(19) United States
(12) Patent Application Publication
(10) Pub. No.: US 2020/0004072 A1
(43) Pub. Date: Jan. 2, 2020

(54) TOUCH PANEL AND METHOD FOR MANUFACTURING THE SAME

(71) Applicants: HKC CORPORATION LIMITED, Shenzhen City, Guangdong (CN); CHONGQING HKC OPTOELECTRONICS TECHNOLOGY CO., LIMITED, Chongqing (CN)

(72) Inventor: Yu-Jen CHEN, Chongqing (CN)

(73) Assignees: HKC Corporation Limited, Shuitian County, Shiyan, Bao'an District (CN); Chongqing HKC Optoelectronics Technology Co., Ltd, Chongqing (CN)

(21) Appl. No.: 15/550,122

(22) PCT Filed: May 10, 2017
(86) PCT No.: PCT/CN2017/083674

§ 371 Date: Oct. 11, 2018

(30) Foreign Application Priority Data
Apr. 5, 2017 (CN) 201710218563.1

(51) Int. Cl. G02F 1/1333; G02F 1/1335; G02F 1/1339; G02F 1/1368; G06F 3/041

(52) U.S. Cl. CPC G02F 1/13338; G02F 1/133516; G02F 1/13394; G02F 2001/136222; G02F 1/1368; G06F 3/0412; G02F 1/133512

(57) ABSTRACT

This application relates to a touch panel and a method for manufacturing the same. The touch panel includes: a first substrate, having a plurality of pixel areas, including: a first base; a color filter (CF) layer, including a plurality of color filters, and formed on the first base; a plurality of photo spacers (PS), formed on the CF layer; and a first insulation layer, formed on the CF layer; and a first electrode, formed on the first insulation layer; a second substrate, disposed opposite to the first substrate, including: a second base; a light shield layer, formed on the second base, and located directly above the PS; and a second electrode, formed on the light shield layer; and a liquid crystal layer, located between the first substrate and the second substrate.

### BACKGROUND

### Technical Field

This application relates to a manufacturing method, and in particular, to a touch panel and a method for manufacturing the same.

### Related Art

With progress of science and technologies, liquid crystal displays with a plurality of advantages, such as power saving, no radiation, small volumes, low power consumption, flat squares, high resolution, and stable picture quality, in particular, various current information products, such as mobile phones, notebook computers, digital cameras, PDAs, and liquid crystal screens, are increasingly popular. As a result, demands for liquid crystal displays (LCDs) are greatly increased, and liquid crystal touch displays are also included.

A conventional liquid crystal touch panel process includes generating a plurality of photo spacers (PS) for touch on a color filter (CF) layer of an upper substrate, then generating a transparent electrode (indium-tin oxide (ITO), also referred to as transparent conductive film glass) on the PS for touch, and conducting the upper substrate and a lower substrates of the liquid crystal touch panel by using pressure of a finger or a hard object, to transmit a signal of a touch area. In either a manufacturing process of a three-color, i.e., red/green/blue (RGB), CF layer or a manufacturing process of a four-color, i.e., red/green/blue/white (RGBW), CF layer, processes of a PS for touch and a transparent electrode (ITO) need to be added after the color photoresist process of the CF layer, and consequently, problems, such as a touch failure due to dislocation of upper and lower substrates during a touch, easily occur.

### SUMMARY

To resolve the foregoing technical problems, this application is directed to providing a touch panel and a method for manufacturing the same, so as to enable a manufactured touch panel to effectively avoid problem, such as a touch failure due to dislocation of upper and lower substrates during a touch, without greatly changing an existing production procedure.

The objective of this application is achieved and the technical problems thereof are resolved by using the following technical solutions. A touch panel provided according to this application comprises: a first substrate, having a plurality of pixel areas, comprising: a first base; a CF layer, comprising a plurality of color filters, and formed on the first base; a PS, formed on the CF layer; and a first insulation layer, formed on the CF layer; and a first electrode, formed on the first insulation layer; a second substrate, disposed opposite to the first substrate, comprising: a second base; a light shield layer, formed on the second base, and located directly above the PS; and a second electrode, formed on the light shield layer; and a liquid crystal layer, located between the first substrate and the second substrate.

This application may further resolve the technical problems thereof by using the following technical measures.

In an embodiment of this application, the light shield layer is a black matrix (BM).

In an embodiment of this application, the CF layer comprises a first color filter, a second color filter, a third color filter, and a fourth color filter.

In an embodiment of this application, the first color filter, the second color filter, the third color filter, and the fourth color filter are red, green, blue, and white color filter.

In an embodiment of this application, a material of the PS is the same as a material of one of the plurality of color filters.

In an embodiment of this application, the second substrate further comprises an adjustment layer, which is in contact the PS.

In an embodiment of this application, the first substrate is an active switch array substrate, and the second substrate is a transparent substrate.

In an embodiment of this application, the transparent substrate faces a backlight module, and the active switch array substrate faces a user.

Another objective of this application is a method for manufacturing a touch panel, comprising: providing a first substrate, comprising a first base; forming a CF layer on the first base, where the CF layer comprises a plurality of color filters; forming a PS on the CF layer; forming a first insulation layer on the CF layer; forming a first electrode on the first insulation layer; providing a second substrate, comprising a second base, and disposed opposite to the second substrate; forming a light shield layer on the second base, where the light shield layer is located directly above the PS; and forming a liquid crystal layer between the first substrate and the second substrate.

This application may further resolve the technical problems thereof by using the following technical measures.

In an embodiment of this application, the manufacturing method further comprises: a material of the PS is the same as a material of one of the plurality of color filters.

In an embodiment of this application, in the manufacturing method, the color filters comprise a white color filter, and the white color filter and the PS are simultaneously completed by means of one process.

In an embodiment of this application, the manufacturing method further comprises: the first substrate is an active switch array substrate, and the second substrate is a transparent substrate.

In an embodiment of this application, in the manufacturing method, the transparent substrate faces a backlight module, and the active switch array substrate faces a user.

Another objective of this application is a touch panel, comprising: a first substrate, having a plurality of pixel areas, comprising: a first base; a CF layer, comprising a plurality of color filters formed on the first base; a PS, formed on the CF layer; and a first insulation layer, formed on the CF layer; and a first electrode, formed on the first insulation layer; a second substrate, disposed opposite to the first substrate, comprising: a second base; a light shield layer, which is a BM, formed on the second base, and located directly above the PS; and a second electrode, formed on the light shield layer; and a liquid crystal layer, located between the first substrate and the second substrate, where the CF layer comprises a first color filter, a second color filter, a third color filter, and a fourth color filter, and the first, second, third, and color filter are red, green, blue, and white color filters.

In an embodiment of this application, a material of the PS is the same as a material of the white color filter.

In an embodiment of this application, the first substrate is an active switch array substrate and faces a user, and the second substrate is a transparent substrate and faces a backlight module.

This application can enable a manufactured touch panel to effectively avoid problems, such as a touch failure due to dislocation of upper and lower substrates during touch, without greatly changing an existing production procedure, is applicable to completing a touch panel product in combination with a three-color panel process, a four-color panel process, or a Color Filter on TFT Side (COT) process, and is applicable to manufacturing a panel of which a PS and a white color filter are made of the same material.

### BRIEF DESCRIPTION OF THE DRAWINGS

FIG. 1a is a schematic sectional view of an exemplary liquid crystal display panel;

FIG. 1b is a schematic sectional view of manufacturing of an exemplary liquid crystal display panel;

FIG. 2a is a schematic sectional view showing manufacturing of a CF layer on an array applied to a liquid crystal touch panel according to a method of this application;

FIG. 2b is a schematic diagram showing contact between upper and lower substrates because the liquid crystal touch panel shown in FIG. 2a is subject to an external force;

FIG. 3a is a schematic sectional view showing manufacturing of a CF layer on an array applied to a liquid crystal touch panel in another embodiment according to a method of this application; and

FIG. 3b is a schematic diagram showing contact between upper and lower substrates because the liquid crystal touch panel shown in FIG. 3a is subject to an external force.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface” merely refer to directions of the accompanying drawings. Therefore, the used terms about directions are used to describe and understand this application, and are not intended to limit this application.

The accompanying drawings and the description are considered to be essentially exemplary, rather than limitative. In figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located on or below a target component, but does not mean that the component needs to be located on top of the gravity direction.

To further describe the technical means adopted in this application to achieve the preset invention objective and effects thereof, specific implementations, structures, features, and effects of a touch panel and a method for manufacturing the same provided according to this application are described below in detail with reference to the drawings and preferred embodiments.

The touch panel in this application may include a first substrate, a second substrate, and a liquid crystal layer formed between the first substrate and the second substrate. The first substrate and the second substrate may be, for example, an active array switch substrate and a CF layer substrate. However, this application is not limited thereto. In some embodiments, an active array switch substrate and a CF layer substrate of this application may also be formed on a same substrate.

In some embodiments, the touch panel of this application may be a curved-surface display panel.

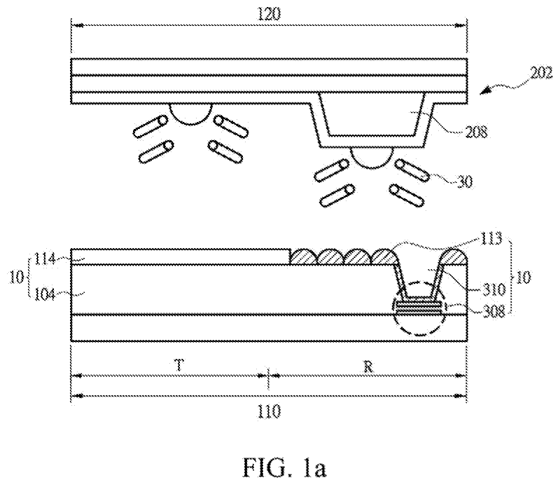

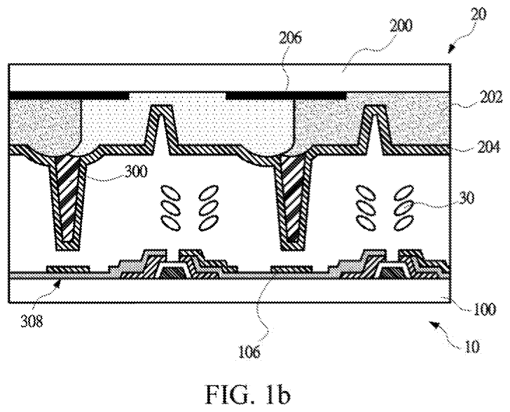

FIG. 1a is a schematic sectional view of an exemplary liquid crystal display panel, and FIG. 1b is a schematic sectional view of manufacturing of an exemplary liquid crystal display panel. A transflective MVA liquid crystal touch panel with dual gaps is used as an example. Usually, a transflective liquid crystal touch panel with dual gaps includes an adjustment layer 208 in a reflection area R. As shown in FIG. 1a, the adjustment layer may be disposed on the side of a CF layer substrate or on the side of an active array switch substrate. As shown in FIG. 1a, a basic structure of the touch panel includes a first substrate 10, a CF layer substrate 202, and a liquid crystal layer 30. The first substrate 10 has a plurality of pixel areas 110, each of which includes a reflection area R and a transmission area T. The CF layer substrate 202 also has a plurality of pixel areas 120, which respectively correspond to the plurality of pixel areas 110 of the first substrate, and each pixel area 120 includes an adjustment layer 208 at a position corresponding to the reflection area R. The liquid crystal layer 30 is disposed between the first substrate 10 and the CF layer substrate 202.

Continuing to refer to FIG. 1a and FIG. 1b, an active array switch is disposed in each pixel area 100 of the first substrate 10, and a storage capacitor 308 is disposed below the reflection area R. Subsequently, a planarization layer 104 is formed on an upper surface of the first substrate 10. Then, a concave-convex surface is made on the planarization layer 104 in the reflection area R, and a metal with high reflectivity (such as aluminum and silver) is plated as a reflection electrode 113. Moreover, the transmission area T of each pixel area 110 also includes a transparent electrode 114. It is worth mentioning that a contact hole 310 is further disposed in the reflection area R of each pixel area 110 of the first substrate 10 to electrically connect the reflection electrode 113 and the storage capacitor 308. As shown in FIG. 1b, usually, when the first substrate 10 is assembled with the second CF layer substrate 202, the CF layer substrate 202 further includes a PS 300, a second electrode 204 is formed on the CF layer substrate 202 and the PS 300, and a plurality of first electrodes 106 corresponding to the PS 300 is designed on the side of the first substrate 10, so that a signal on a touched part is transmitted by means of contact between the second electrode 204 on the PS 300 and the first electrode 106 during a touch. Although a reflective liquid crystal display panel with a wide viewing angle is used as an example for the foregoing description, the application scope of this application is not limited thereto, and this application may further be applied to liquid crystal touch panels of various types.

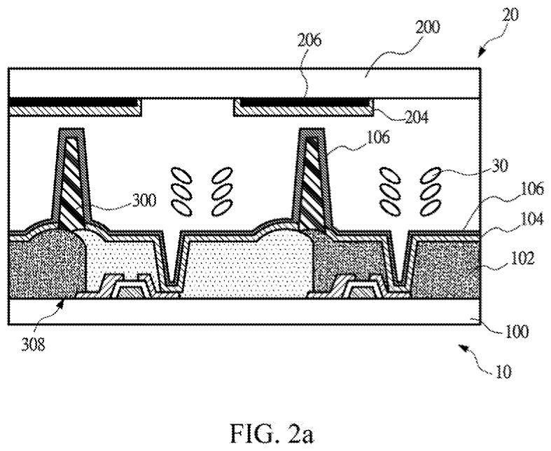

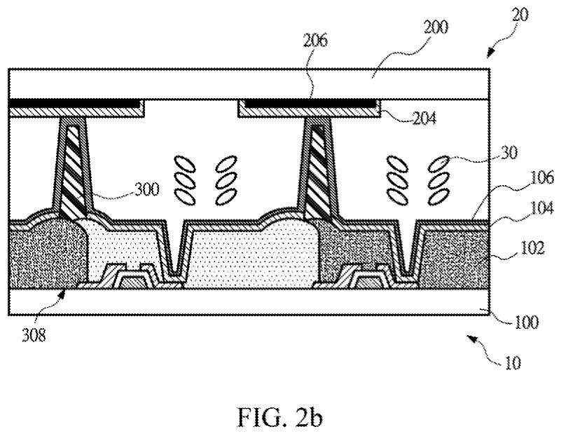

FIG. 2a is a schematic sectional view showing manufacturing of a CF layer on an array applied to a liquid crystal touch panel according to a method of this application. Referring to FIG. 2a, in an embodiment of this application, the touch panel includes: a first substrate 10, having a plurality of pixel areas, including: a first base 100; a CF layer 102, including a plurality of color filters, and formed on the first base 100; a PS 300, formed on the CF layer 102; and a first insulation layer 104, formed on the CF layer 102; and a first electrode 106, formed on the first insulation layer 104; a second substrate 20, disposed opposite to the first substrate 10, including: a second base 200; a light shield layer 206, formed on the second base 200, and located directly above the PS 300; and a second electrode 204, formed on the light shield layer 206; and a liquid crystal layer 30, located between the first substrate 10 and the second substrate 20. The first electrode 106 and the second electrode 204 are both made of indium-tin oxide (ITO).

In some embodiments, the CF layer 102 includes a plurality of color filters disposed in parallel, and the CF layer 102, for example, may include a first color filter, a second color filter, and a third color filter. In some embodiments, the first color filter, the second color filter, and the third color filter, for example, may be red, green and blue color filters.

In some embodiments, the light shield layer 206 is a BM.

In some embodiments, the first substrate 10 further includes an adjustment layer 208, which is in contact with the PS 300.

In some embodiments, the plurality of color filters of the CF layer 102, for example, may include a yellow color filter or a color filter of another color.

In some embodiments, the first substrate 10 is an active switch array substrate, and the second substrate 20 is a transparent substrate.

In some embodiments, the transparent substrate faces a backlight module, and the active switch array substrate faces a user.

FIG. 2b is a schematic diagram showing contact between upper and lower substrates because the liquid crystal touch panel shown in FIG. 2a is subject to an external force. As shown in FIG. 2b, when the panel is touched by a finger or a hard object, a signal on a touched part is transmitted by means of contact between the first electrode 106 on the PS 300 and the second electrode 204.

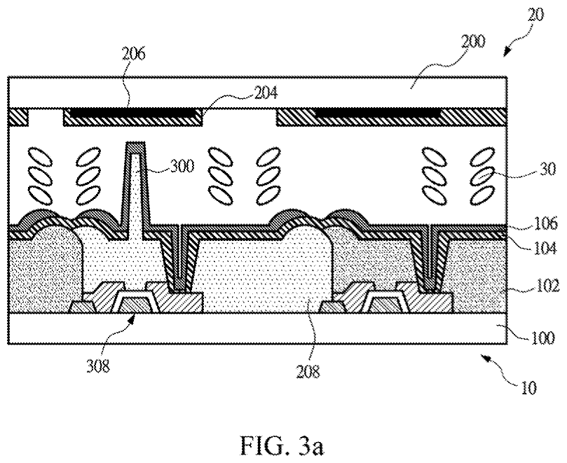

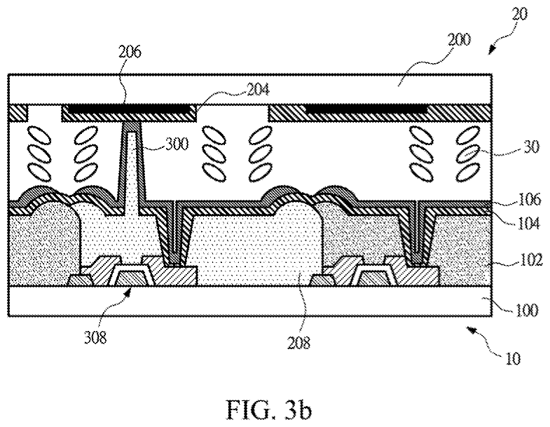

FIG. 3a is a schematic sectional view showing manufacturing of a CF layer on an array applied to a liquid crystal touch panel in another embodiment according to a method of this application. Referring to FIG. 3a, in another embodiment of this application, the touch panel includes: a first substrate 10, having a plurality of pixel areas, including: a first base 100; a CF layer 102, including a plurality of color filters, and formed on the first base 100; a PS 300, formed on the CF layer 102; and a first insulation layer 104, formed on the CF layer 102; and a first electrode 106, formed on the first insulation layer 104; a second substrate 20, disposed opposite to the first substrate 10, including: a second base 200; a light shield layer 206, formed on the second base 200, and located directly above the PS 300; and a second electrode 204, formed on the light shield layer 206; and a liquid crystal layer 30, located between the first substrate 10 and the second substrate 20. The first electrode 106 and the second electrode 204 are both made of ITO.

In some embodiments, the CF layer 102 includes a plurality of color filters disposed in parallel, and the CF layer 102, for example, may include a first color filter, a second color filter, a third color filter, and a fourth color filter. In some embodiments, the first color filter, the second color filter, the third color filter, and the fourth color filter, for example, may be red, green, blue, and white color filters, and the material of one of the first color filter, the second color filter, the third color filter, and the fourth color filter is the same as the material of the PS 300.

In some embodiments, the light shield layer 206 is a BM.

In some embodiments, the first substrate 10 further includes an adjustment layer 208, which is in contact with the PS 300.

In some embodiments, the material of the PS 300 may be the same as the material of one of the plurality of color filters, for example, the material of the white color filter.

In some embodiments, the plurality of color filters of the CF layer 102, for example, may include a yellow color filter or a color filter of another color.

In some embodiments, the first substrate 10 is an active switch array substrate, and the second substrate 20 is a transparent substrate.

In some embodiments, the transparent substrate faces a backlight module, and the active switch array substrate faces a user.

FIG. 3b is a schematic diagram showing contact between upper and lower substrates because the liquid crystal touch panel shown in FIG. 3a is subject to an external force. As shown in FIG. 2b, when the panel is touched by a finger or a hard object, a signal on a touched part is transmitted by means of contact between the first electrode 106 on the PS 300 and the second electrode 204.

In an embodiment of this application, a method for manufacturing a touch panel of this application includes: providing a first substrate 10, including a first base 100; forming a CF layer 102 on the first base 100, where the CF layer 102 includes a plurality of color filters; forming a PS 300 on the CF layer 102; forming a first insulation layer 104 on the CF layer 102; forming a first electrode 106 on the first insulation layer 104; providing a second substrate 20, including a second base 200, and disposed opposite to the first substrate 10; forming a light shield layer 206 on the second base 200, where the light shield layer 206 is located directly above the PS 300; and forming a liquid crystal layer 30 between the first substrate 10 and the second substrate 20.

In some embodiments, the CF layer 102 includes a plurality of color filters disposed in parallel, and the CF layer 102, for example, may include a first color filter, a second color filter, and a third color filter. In some embodiments, the first color filter, the second color filter, and the third color filter, for example, may be red, green and blue color filters.

In some embodiments, the light shield layer 206 is a BM.

In some embodiments, the plurality of color filters of the CF layer 102, for example, may include a yellow color filter or a color filter of another color.

In some embodiments, the first substrate 10 is an active switch array substrate, and the second substrate 20 is a transparent substrate.

In some embodiments, the transparent substrate faces a backlight module, and the active switch array substrate faces a user.

In some embodiments, the CF layer 102 includes a plurality of color filters disposed in parallel, and the CF layer 102, for example, may include a first color filter, a second color filter, a third color filter, and a fourth color filter. In some embodiments, the first color filter, the second color filter, the third color filter, and the fourth color filter, for example, may be red, green, blue, and white color filters, and the material of one of the first color filter, the second color filter, the third color filter, and the fourth color filter is the same as the material of the PS 300. When adjustment of brightness sensitivity, transmittance, and chrominance of the PS 300 is applied to forming the CF layer 102 on the first base 100, the material of the white color filter is replaced with the material of the PS 300, the manufacturing of the white color filter and manufacturing of the PS 300 are simultaneously completed, and a required segment gap of the PS 300 is made, and an advantage is omitting a process of the PS 300.

This application can enable a manufactured touch panel to effectively avoid problems, such as a touch failure due to dislocation of upper and lower substrates during touch, without greatly changing an existing production procedure, is applicable to completing a touch panel product in combination with a three-color panel process, a four-color panel process, or a COT process, and is applicable to manufacturing a panel of which a PS 300 and a white color filter are made of the same material

Terms such as “in some embodiments” and “in various embodiments” are repeatedly used. Usually, the terms do not refer to the same embodiment; but they may also refer to the same embodiment. Words such as “comprise”, “have”, “include” are synonyms, unless other meanings are indicated in the context.

The foregoing descriptions are merely preferred embodiments of this application, and are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change or modification made to the foregoing embodiments according to the technical essence of this application without departing from the content of the technical solutions of this application shall fall within the scope of the technical solutions of this application.

What is claimed is:

1. A touch panel, comprising:
a first substrate, having a plurality of pixel areas, comprising:
a first base;
a color filter (CF) layer, comprising a plurality of color filters, and formed on the first base;
a plurality of photo spacers (PS), formed on the CF layer; and
a first insulation layer, formed on the CF layer; and
a first electrode, formed on the first insulation layer;
a second substrate, disposed opposite to the first substrate, and comprising:
a second base;
a light shield layer, formed on the second base, and located directly above the photo spacers; and
a second electrode, formed on the light shield layer; and
a liquid crystal layer, located between the first substrate and the second substrate.

2. The touch panel according to claim 1, wherein the light shield layer is a black matrix.

3. The touch panel according to claim 1, wherein the CF layer comprises a first color filter, a second color filter, a third color filter, and a fourth color filter.

4. The touch panel according to claim 3, wherein the first color filter, the second color filter, the third color filter, and the fourth color filter are red, green, blue, and white color filters.

5. The touch panel according to claim 1, wherein a material of the PS is the same as a material of one of the plurality of color filters.

6. The touch panel according to claim 1, wherein the second substrate further comprises an adjustment layer, which is in contact with the PS.

7. The touch panel according to claim 1, wherein the first substrate is an active switch array substrate, and the second substrate is a transparent substrate.

8. The touch panel according to claim 7, wherein the transparent substrate faces a backlight module, and the active switch array substrate faces a user.

9. A method for manufacturing a touch panel, comprising:
providing a first substrate comprising a first base;
forming a color filter (CF) layer on the first base, wherein the CF layer comprises a plurality of color filters;
forming a plurality of photo spacers (PS) on the CF layer;
forming a first insulation layer on the CF layer;
forming a first electrode on the first insulation layer;
providing a second substrate, comprising a second base, and disposed opposite to the first substrate;
forming a light shield layer on the second base, wherein the light shield layer is located directly above the PS; and
forming a liquid crystal layer between the first substrate and the second substrate.

10. The method for manufacturing a touch panel according to claim 9, further comprising: a material of the PS is the same as a material of one of the plurality of color filters.

11. The method for manufacturing a touch panel according to claim 9, wherein the color filters comprise a white color filter.

12. The method for manufacturing a touch panel according to claim 11, wherein the white color filter and the PS are simultaneously completed by means of one process.

13. The method for manufacturing a touch panel according to claim 9, further comprising: the first substrate is an active switch array substrate, and the second substrate is a transparent substrate.

14. The method for manufacturing a touch panel according to claim 13, wherein the transparent substrate faces a backlight module, and the active switch array substrate faces a user.

15. A touch panel, comprising:
a first substrate, having a plurality of pixel areas, comprising:
a first base;
a color filter (CF) layer, comprising a plurality of color filters formed on the first base;
a plurality of photo spacers (PS), formed on the CF layer; and
a first insulation layer, formed on the CF layer; and
a first electrode, formed on the first insulation layer;
a second substrate, disposed opposite to the first substrate, comprising:
a second base;
a light shield layer, which is a black matrix, formed on the second base, and located directly above the PS; and
a second electrode, formed on the light shield layer; and
a liquid crystal layer, located between the first substrate and the second substrate, wherein
the CF layer comprises a first color filter, a second color filter, a third color filter, and a fourth color filter, and the first, second, third, and fourth color filters are red, green, blue, and white color filters;
a material of the PS is the same as a material of the white color filter; and
the first substrate is an active switch array substrate and faces a user, and the second substrate is a transparent substrate and faces a backlight module.
